(19) United States
(12) Patent Application Publication
(10) Pub. No.: US 2012/0074859 A1
(43) Pub. Date: Mar. 29, 2012

(54) DRIVER FOR LIGHT EMITTING DIODES

(75) Inventors: Seung Kon KONG, Seongnam (KR); Jae Shin LEE, Anyang (KR); Bo Hyun HWANG, Seoul (KR); Jung Hyun KIM, Suwon (KR); Jung Eui PARK, Suwon (KR); Joon Youp SUNG, Seoul (KR)

(73) Assignee: SAMSUNG ELECTRO-MECHANICS CO., LTD.

(21) Appl. No.: 13/186,110

(22) Filed: Jul. 19, 2011

(30) Foreign Application Priority Data
Sep. 29, 2010 (KR) 10-2010-0094340

(51) Int. Cl. H05B 37/02

(52) U.S. Cl. 315/210

(57) ABSTRACT

There is provided a driver for light emitting diodes capable of differently setting duties in which driving current flows depending on respective light emitting diode (LED) channels according to a voltage deviation between the LED channels in order to reduce heat generated due to the voltage deviation between the LED channels. The driver for LEDs includes: a detecting unit detecting a voltage drop generated in each of a plurality of LED channels receiving driving power having a preset voltage level; a converting unit converting detected analog values from the detecting unit into digital values; and a driving unit differently setting switching duties in which driving current flows in each of the plurality of LED channels according to the digital values from the converting unit to drive the plurality of LED channels.

### CROSS-REFERENCE TO RELATED APPLICATIONS

This application claims the priority of Korean Patent Application No. 10-2010-0094340 filed on Sep. 29, 2010, in the Korean Intellectual Property Office, the disclosure of which is incorporated herein by reference.

### BACKGROUND OF THE INVENTION

1. Field of the Invention

The present invention relates to a driver for light emitting diodes, and more particularly, to a driver for light emitting diodes capable of differently setting duties in which a driving current flows depending on respective light emitting diode (LED) channels according to voltage deviations between the LED channels, in order to reduce heat generated due to the voltage deviations between the LED channels.

2. Description of the Related Art

In the field of display devices, the development of new technology such as a flat panel display (FPD) has reflecting the preference, in the current multimedia age, for features such as high resolution, a large screen, and the like. Particularly, in the case of the large display device market, the market share of a liquid crystal display (LCD) TV has rapidly grown, such that this factor will play an important role in view of cost and marketability in the future.

A Cold Cathode Fluorescent Lamp (CCFL) has been mainly used as a backlight light source in the LCD TV, according to the related art. However, recently, the adoption of a Light Emitting Diode (hereinafter, referred to as an ‘LED’) has gradually increased, due to various advantages such as power consumption, life span, environmentally friendly characteristics, and the like. Therefore, the demand for a configuration of a low-cost electronic system for a backlight unit power module using the LED, and an appropriate controlling element therefor has been urgently increased.

In order to satisfy this demand, according to the related art, a switch element has been used in order to control each of a plurality of LED channels with a constant current. However, the LED channels have been configured with a plurality of LEDs connected in series to cause a voltage deviation between the LEDs, such that current non-uniformity may occur between LED channels, thereby resulting in non-uniform brightness.

### SUMMARY OF THE INVENTION

An aspect of the present invention provides a driver for light emitting diodes (LED) capable of differently setting duties in which driving current flows depending on respective LED channels according to voltage deviation between the LED channels in order to reduce heat generated due to the voltage deviation between the LED channels.

According to an aspect of the present invention, there is provided a driver for LEDs, the driver including: a detecting unit detecting voltage drop generated in each of a plurality of LED channels receiving driving power having a preset voltage level; a converting unit converting detected analog values from the detecting unit into digital values; and a driving unit differently setting switching duties in which driving current flows in each of the plurality of LED channels according to the digital values from the converting unit to drive the plurality of LED channels.

The detecting unit may include a plurality of detectors respectivley corresponding to the plurality of LED channels and detecting the voltage drop of a corresponding LED channel.

The driving unit may include a plurality of drivers respectively corresponding to the plurality of LED channels and setting the switching duty in which the driving current flows in a corresponding LED channel to drive the corresponding LED channel.

The driver for LEDs may further include a switch unit selecting the detected value from each of the plurality of detectors to transfer the selected detected value to the converting unit, and selecting the digital value from the converting unit to transfer the selected digital value to each of the plurality of drivers.

The switch unit may include: a first selection switch selecting the detected value from each of the plurality of detectors to transfer the selected detected value to the converting unit; and a second selection switch selecting the digital value from the converting unit to transfer the selected digital value to each of the plurality of drivers.

The driving unit may set a switching on duty to be long when the voltage drop is larger than a reference voltage, and set the switching on duty to be short when the voltage drop is smaller than the reference voltage.

The detecting unit, the converting unit, and the driving unit may be configured as at least one integrated circuit.

The driver for LEDs may further include a plurality of switches individually connected between the plurality of LED channels and a ground to be turned on or turned off according to the switching duty set by the driving unit, thereby driving the corresponding LED channel.

The driver for LEDs may further include a plurality of buffers buffering switching duty signals from the driving unit to transfer the buffered switching duty signals to the corresponding switches.

The converting unit may include a plurality of converters respectively corresponding to the plurality of detectors and converting the analog values detected from each of the plurality of detectors into the digital values to transfer the converted digital values to the corresponding driver of the plurality of drivers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a driver for LEDs according to an exemplary embodiment of the present invention;

FIG. 2 is a view showing a driver for LEDs according to another exemplary embodiment of the present invention; and

FIG. 3 is an operation graph of a driver for LEDs according to an exemplary embodiment of the present invention.

### DETAILED DESCRIPTION OF THE PREFERRED EMBODIMENT

Hereinafter, exemplary embodiments of the present invention will now be described in detail with reference to the accompanying drawings.

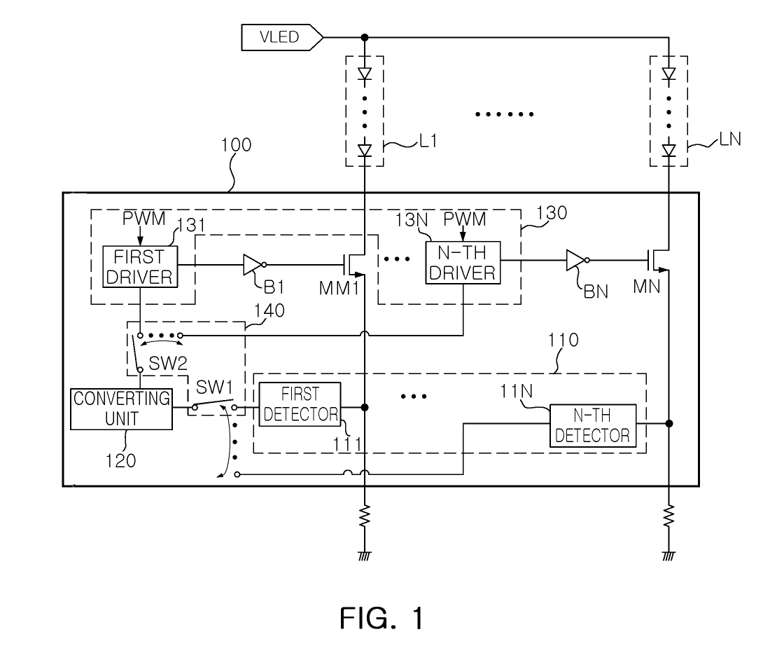

FIG. 1 is a view showing a driver for light emitting diodes (LED) according to an exemplary embodiment of the present invention.

Referring to FIG. 1, a driver 100 for LEDs may include a detecting unit 110, a converting unit 120, and a driving unit 130, and may further include a switch unit 140.

The detecting unit 110 may detect a voltage drop in a plurality of LED channels L1 to LN each having a plurality of LEDs connected in series. The plurality of LED channels L1 to LN may emit light by receiving driving power VLED having a preset voltage level, respectively. At this time, each of the LEDs may drop a voltage level of the received power, wherein voltage drop values of the LEDs maybe different. The detecting unit 110 may detect voltage drop values of the plurality of LED channels L1 to LN, and may include a plurality of detectors 111 to 11N respectively corresponding to the plurality of LED channels L1 to LN to detect the voltage drop values of each of the plurality of LED channels L1 to LN.

The converting unit 120 may convert analog type detected values detected in the detecting unit 110 into digital type detected values to transfer the digital type detected values to the driving unit 130.

The driving unit 130 may set switching duties controlling the driving of the plurality of LED channels L1 to LN according to the digital type detected values from the converting unit 120 and may transfer switching signals having the set switching duty to the plurality of LED channels L1 to LN. To this end, the driving unit 130 may include a plurality of drivers 131 to 13N, wherein each of the plurality of drivers 131 and 13N may correspond to each of the plurality of LED channels L1 to LN and transfer the switching signals to the corresponding LED channels L1 to LN. Meanwhile, each of the plurality of drivers 131 to 13N may receive a dimming signal PWM from the outside, and may drive the plurality of LED channels L1 to LN when the dimming signal PWM is a switching on signal. The plurality of drivers 131 to 13N may individually set the switching duties according to the digital type detected values detected from the corresponding LED channels L1 to LN. That is, each of the plurality of drivers 131 to 13N may set a switching on duty to be long when the voltage drop value of the corresponding LED channels L1 to LN is relatively large, and may set the switching on duty to be short when the voltage drop value of the corresponding LED channels L1 to LN is relatively small. Accordingly, brightness between the plurality of LED channels L1 to LN may become uniform, and heat generation due to a voltage drop deviation between the plurality LED channels L1 to LN may be reduced. In addition, the driver for LEDs according to an exemplary embodiment of the present invention may be implemented as at least one integrated circuit by the above-mentioned reduction of the heat generation.

The switch unit 140 may include a first selection switch SW1 and a second selection switch SW2, wherein the first selection switch SW1 may selectively provide a connection between the converting unit 120 and the plurality of detectors 111 to 11N and the second selection switch SW 2 may selectively provide a connection between the converting unit 120 and the plurality of drivers 131 to 13N.

The driver for LEDs according to an exemplary embodiment of the present invention may further include a plurality of switches M1 to MN. The plurality of switches M1 to MN may be respectively connected between the plurality of LED channels L1 to LN and a ground to be switched on or switched off according to the switching signals from the driving unit 130, thereby allowing current to flow or blocking the current in the corresponding LED channels L1 to LN. In addition, the driver for LEDs according to an exemplary embodiment of the present invention may further include a plurality of buffers B1 to BN buffering the switching signals from each of the plurality of drivers 131 to 13N to transfer the buffered switching signals to the corresponding switches M1 to MN.

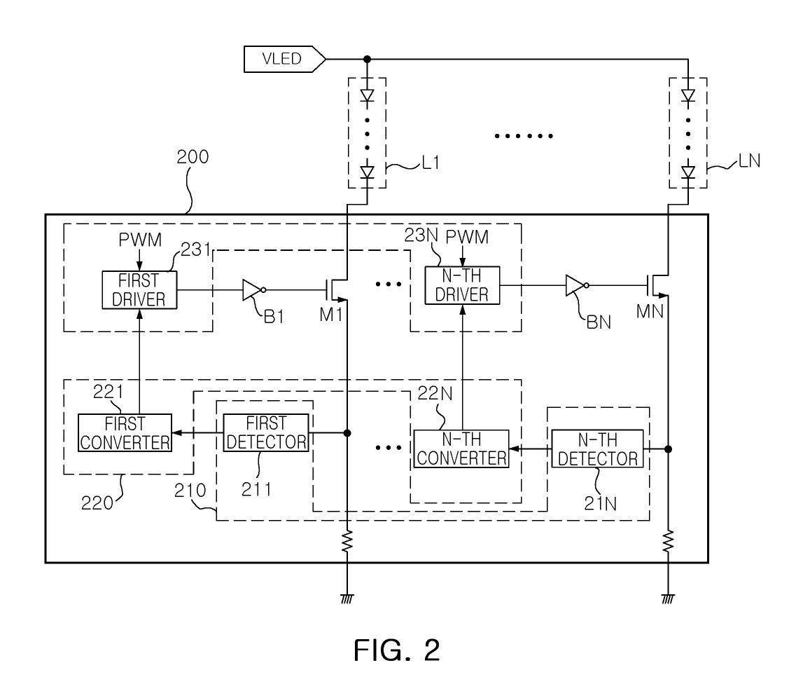

FIG. 2 is a view showing a driver for LEDs according to another exemplary embodiment of the present invention.

Referring to FIG. 2, in a driver 200 for LEDs according to another exemplary embodiment of the present invention, the converting unit 220 may include a plurality of converters 221 to 22N, wherein the plurality of converters 221 to 22N may individually correspond to the plurality of detectors 211 to 21N and the plurality of drivers 231 to 23N, and convert analog type detected values from the corresponding detectors into digital type detected values to transfer the digital type detected values to the corresponding drivers. Accordingly, the switch unit 140 may be omitted, as compared to the driver 100 for LEDs according to an exemplary embodiment of the present invention. Since a detecting unit 210 and a driving unit 230 are the same as the detecting unit 110 and the driving unit 130 shown in FIG. 1, a detailed description thereof will be omitted.

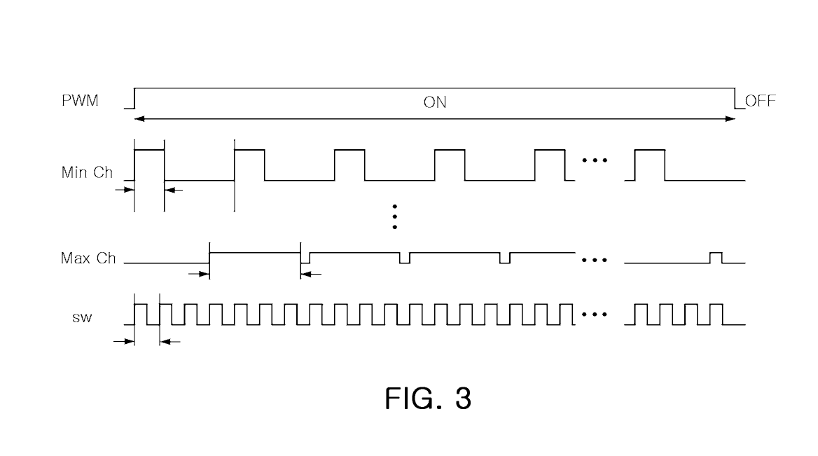

FIG. 3 is an operation graph of a driver for LEDs according to an exemplary embodiment of the present invention.

Referring to FIGS. 1 and 3, only when the dimming signal PWM from the outside is switched on, the driving unit 130 may transfer the switching signals to the corresponding LED channels L1 to LN. At this time, the switching on duty in which the switches M1 to MN are switched on is set to be long when the voltage drop in the corresponding LED channels L1 to LN is larger than a preset reference voltage level, and the switching on duty in which the switches M1 to MN are switched on is set to be short when the voltage drop in the corresponding LED channels L1 to LN is smaller than the preset reference voltage level (Min Ch, Max Ch).

In the driver 100 for LEDs according to an exemplary embodiment of the present invention shown in FIG. 1, a selection signal sw may be provided in order to selectively operate the first and second selection switches SW1 and SW2. Accordingly, the synchronization is performed between the selection signal sw and the switching signals Min Ch and Max Ch, whereby the switching on duty of the switching signal of the corresponding LED channel may be set to be varied according to a change in the voltage drop in the corresponding LED channel.

The operation graph shown in FIG. 3 may be equally applied to the driver 200 for LEDs according to another exemplary embodiment of the present invention shown in FIG. 2 with exception of the selection signal sw.

As set forth above, according to the exemplary embodiments of the present invention, the switching on duties in which the driving current flows are differently set depending on respective LED channels according to the voltage deviation between the LED channels, whereby heat generated due to the voltage deviation between the LED channels maybe reduced, the brightness between the LED channels may be uniformly maintained, and the driver for LEDs may be implemented as a single integrated circuit.

While the present invention has been shown and described in connection with the exemplary embodiments, it will be apparent to those skilled in the art that modifications and variations can be made without departing from the spirit and scope of the invention as defined by the appended claims.

What is claimed is:

1. A driver for a light emitting diode (LED), comprising:
a detecting unit detecting a voltage drop generated in each of a plurality of LED channels receiving driving power having a preset voltage level;
a converting unit converting detected analog values of the detecting unit into digital values; and
a driving unit differently setting switching duties in which driving current flows in each of the plurality of LED channels according to the digital values from the converting unit to drive the plurality of LED channels.

2. The driver for LEDs of claim 1, wherein the detecting unit includes a plurality of detectors respectivley corresponding to the plurality of LED channels and detecting the voltage drop of the corresponding LED channel.

3. The driver for LEDs of claim 2, wherein the driving unit includes a plurality of drivers respectively corresponding to the plurality of LED channels and setting the switching duty in which the driving current flows in the corresponding LED channel to drive the corresponding LED channel.

4. The driver for LEDs of claim 3, further comprising a switching unit selecting the detected value from each of the plurality of detectors to transfer the selected detected value to the converting unit, and selecting the digital value from the converting unit to transfer the selected digital value to each of the plurality of drivers.

5. The driver for LEDs of claim 4, wherein the switching unit includes:
a first selection switch selecting the detected value from each of the plurality of detectors to transfer the selected detected value to the converting unit; and
a second selection switch selecting the digital value from the converting unit to transfer the selected digital value to each of the plurality of drivers.

6. The driver for LEDs of claim 3, wherein the converting unit includes a plurality of converters respectively corresponding to the plurality of detectors and converting the analog values detected from each of the plurality of detectors into the digital values to transfer the converted digital values to the corresponding driver of the plurality of drivers.

7. The driver for LEDs of claim 1, wherein the driving unit sets a switching on duty to be long when the voltage drop is larger than a reference voltage, and sets the switching on duty to be short when the voltage drop is smaller than the reference voltage.

8. The driver for LEDs of claim 1, wherein the detecting unit, the converting unit, and the driving unit are configured as at least one integrated circuit.

9. The driver for LEDs of claim 1, further comprising a plurality of switches respectively connected between the plurality of LED channels and a ground to be turned on or turned off according to the switching duty set by the driving unit, thereby driving the corresponding LED channel.

10. The driver for LEDs of claim 9, further comprising a plurality of buffers buffering switching duty signals from the driving unit to transfer the buffered switching duty signals to the corresponding switches.
